(19) United States
(12) Patent Application Publication
(10) Pub. No.: US 2018/0370667 A1
(43) Pub. Date: Dec. 27, 2018

(54) PACKAGING SYSTEM WITH FLEXIBLE OBJECT

(71) Applicant: Altria Client Services LLC, Richmond, VA (US)

(72) Inventors: William J. BOGDZIEWICZ, Richmond, VA (US); Scott A. Fath, Richmond, VA (US); Ryan A. Bailey, Richmond, VA (US); Robert T. Mitten, Glen Allen, VA (US)

(21) Appl. No.: 15/631,189

(22) Filed: Jun. 23, 2017

(51) Int. Cl. B65B 19/22; B65D 75/00; B65B 59/04; B65D 33/00

(52) U.S. Cl. CPC B65B 19/226; B65D 75/008; A24F 47/00; B65D 33/007; B31B 23/00; B65B 59/04

(57) ABSTRACT

A packaging system configured to hold objects therein may include a tray that includes a cavity and a set of lugs on an inner surface of the cavity. A first object may be located within the cavity, where the first object is isolated from simultaneously engaging each lug in the set of lugs. A flexible object may be at least partially located within the cavity. The flexible object may be bent and engaged against the set of lugs, such that the flexible object is held in place at least partially within the cavity by the set of lugs and the first object is held within the cavity by the flexible object.

### BACKGROUND

### Field

The present disclosure relates in general to electronic vaping devices or e-vaping devices, and in particular to a packaging system that includes a tray holding one or more e-vaping device elements in place via a bent flexible element that is itself held in place by one or more lugs of the tray.

### Description of Related Art

E-vaping devices, also referred to herein as electronic vaping devices (EVDs) may be used by adult vapers for portable vaping. One or more elements of an e-vaping device may be included in a package in which the one or more elements may be held in place by one or more portions of the packaging.

### SUMMARY

According to some example embodiments, a packaging system may include a tray including a cavity and a set of lugs on an inner surface of the cavity, a first object located within the cavity, and a flexible object at least partially located within the cavity. The flexible object may be bent and engaged against the set of lugs such that the flexible object is held in place at least partially within the cavity by the set of lugs and the first object is held within the cavity by the flexible object.

The tray may further include an additional cavity configured to hold an additional object within the additional cavity. The additional object may be a rechargeable battery.

The inner surface of the cavity may include two opposing sidewall surfaces. The set of lugs may include a separate lug on each wall of the two opposing sidewall surfaces.

The first object may include a cartridge for an e-vaping device.

According to some example embodiments, a method may include placing a first object within a cavity of a tray, the tray further including a set of lugs on an inner surface of the cavity, such that the first object is isolated from simultaneously engaging each lug of the set of lugs. The method may further include placing a bent flexible object within the cavity, such that the bent flexible object is held in place at least partially within the cavity by the set of lugs, and the first object is held within the cavity by at least the bent flexible object.

The tray may further include an additional cavity configured to hold an additional object within the additional cavity. The method may further include placing the additional object within the additional cavity, such that the additional object is held in place in the additional cavity. The additional object may be a rechargeable battery.

The inner surface of the cavity may include two opposing sidewall surfaces. The set of lugs may include a separate lug on each wall of the two opposing sidewall surfaces.

The first object may include a cartridge for an e-vaping device.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1A is a perspective view of a packaging system including a bent flexible element according to some example embodiments.

FIG. 1B is a cross-sectional view of the packaging system of FIG. 1A along cross-sectional line IB-IB′ according to some example embodiments.

FIG. 2A is a perspective view of the tray included in the packaging system of FIG. 1A according to some example embodiments.

FIG. 2B, FIG. 2C, FIG. 2D, and FIG. 2E are orthogonal views of the tray of FIG. 2A according to some example embodiments.

FIG. 3 is a flowchart illustrating a method for assembling a packaging system that includes a bent flexible object according to some example embodiments.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

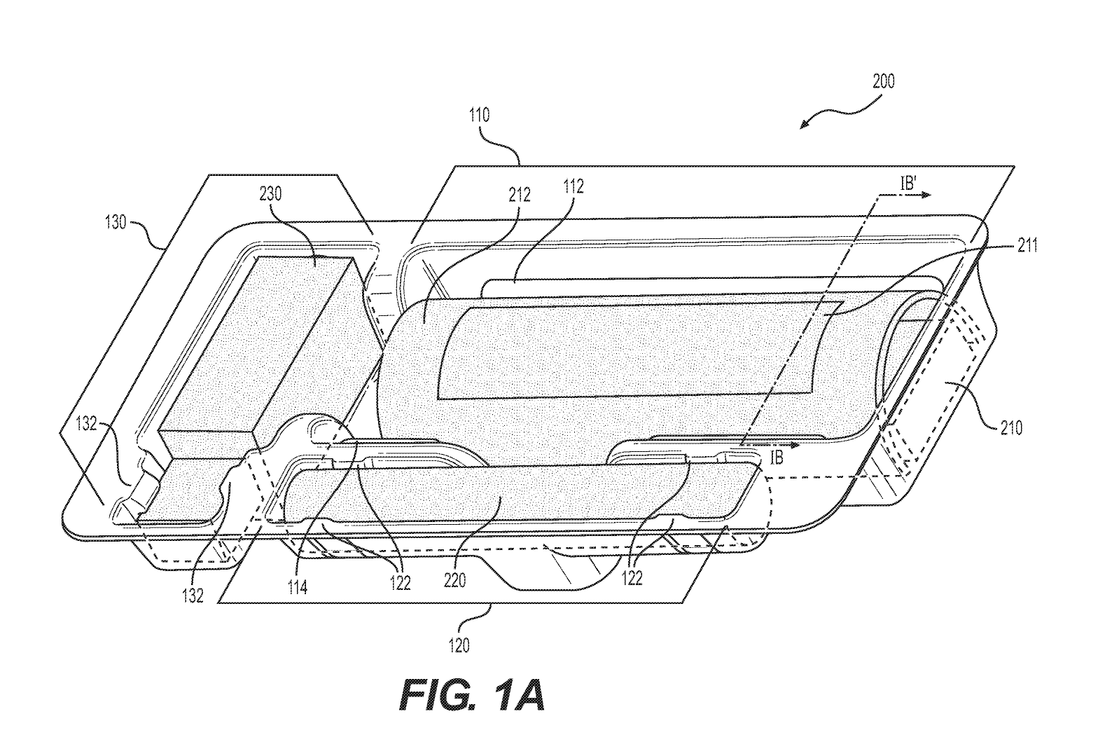

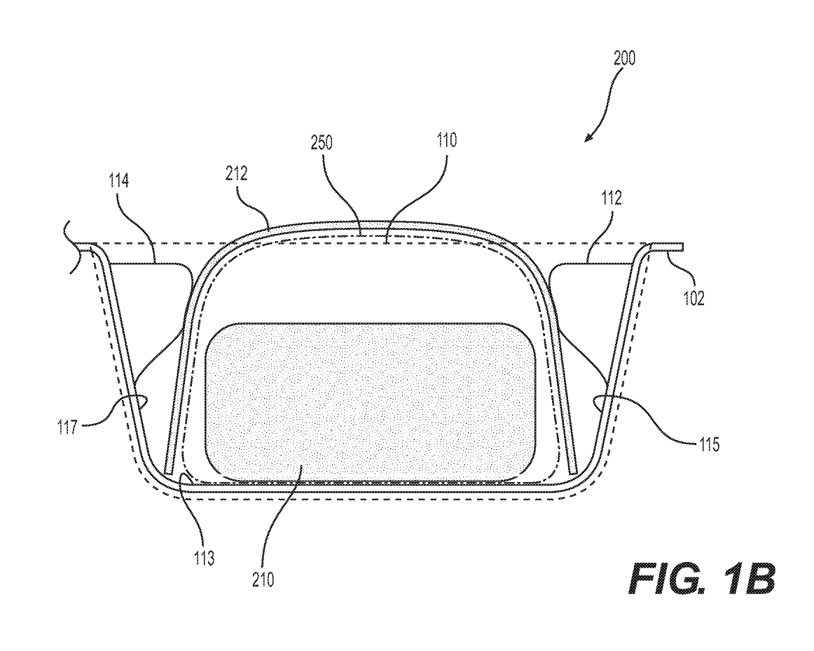

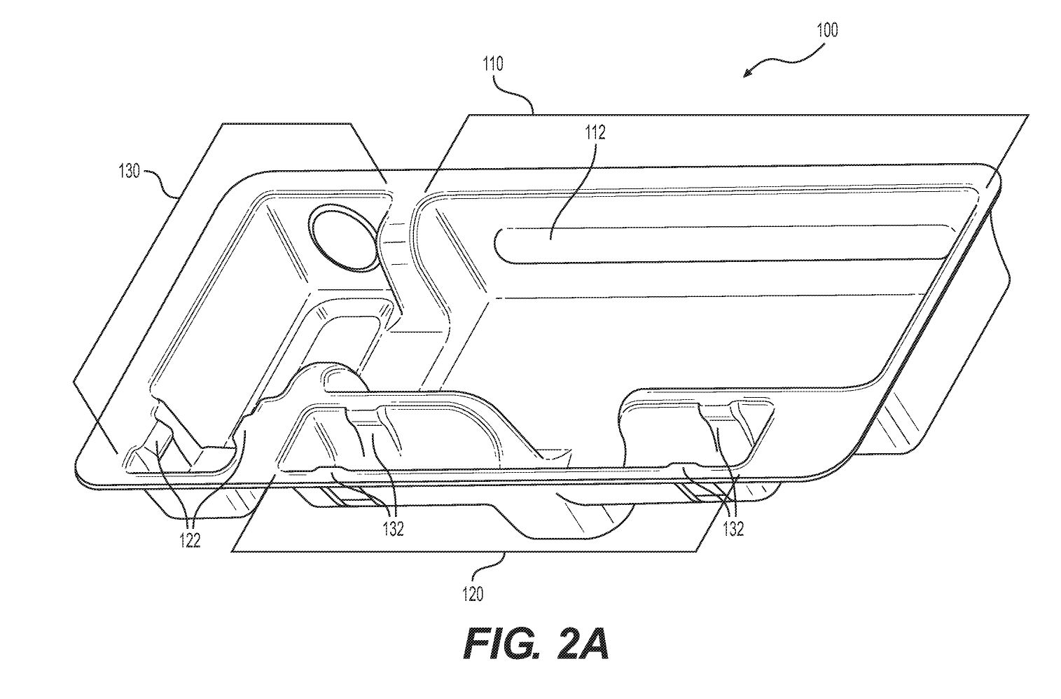

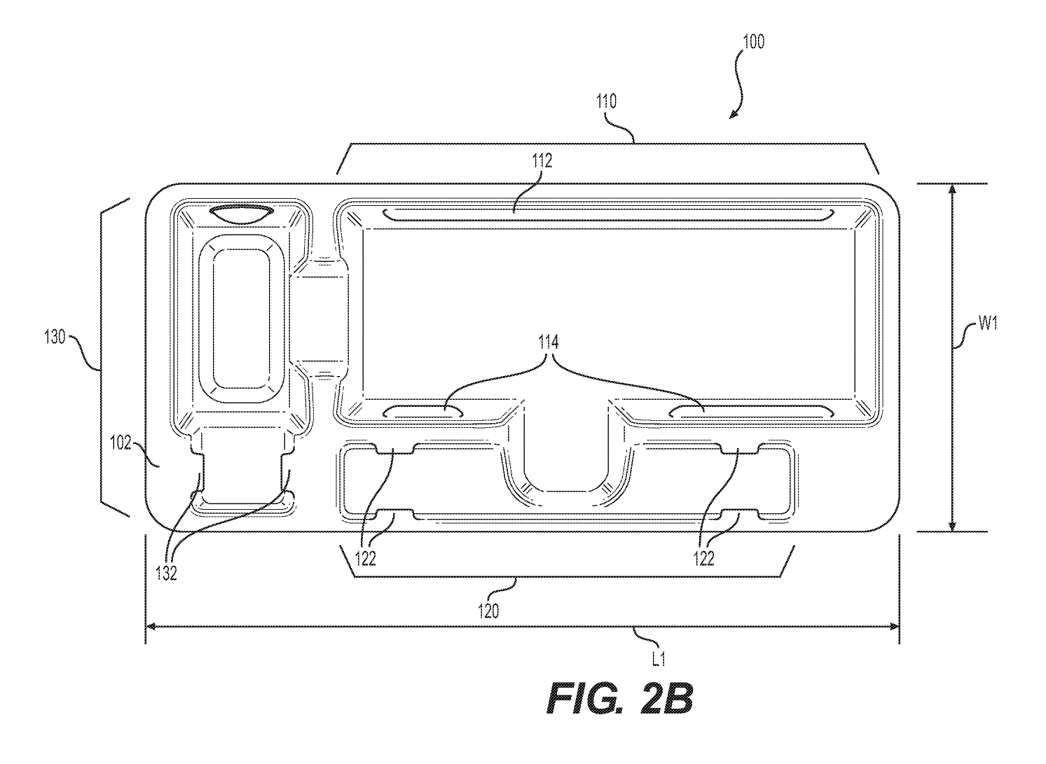

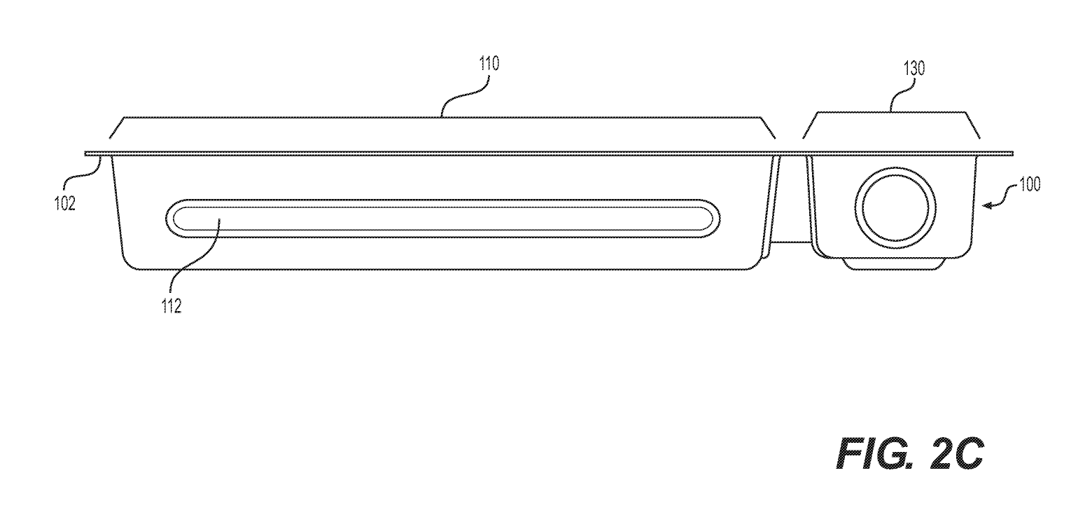

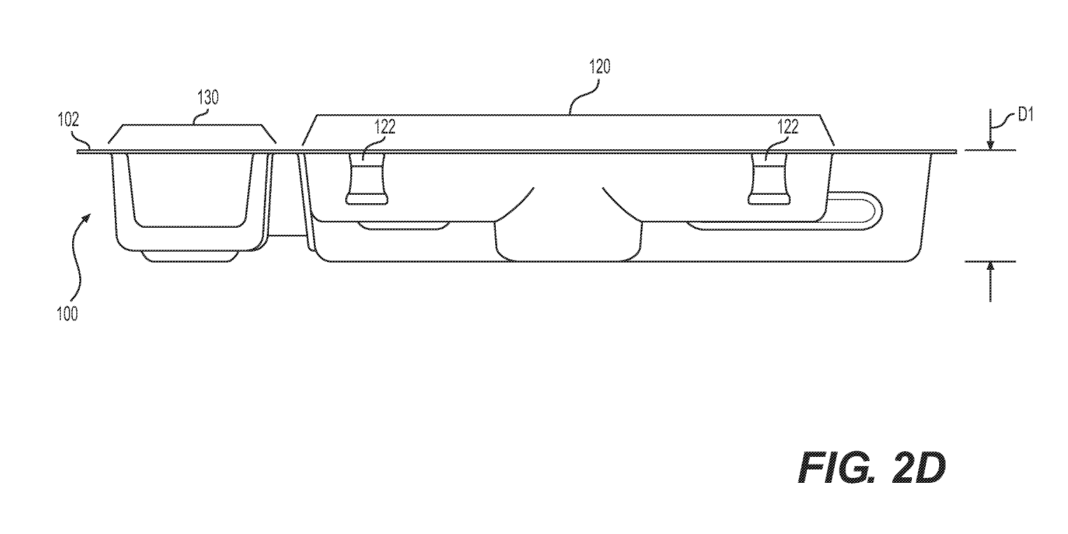

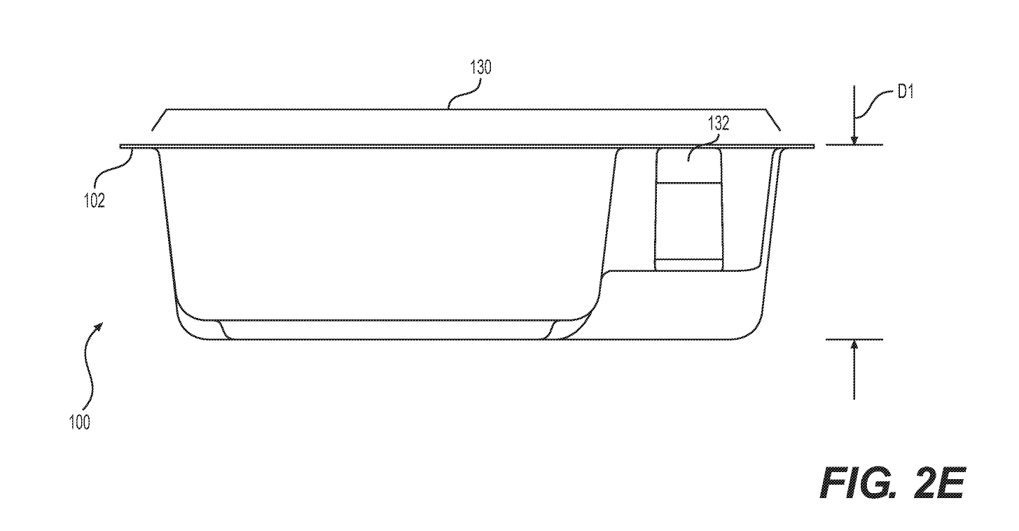

FIG. 1A is a perspective view of a packaging system including a tray and a bent flexible element according to some example embodiments. FIG. 1B is a cross-sectional view of the packaging system of FIG. 1A along cross-sectional line IB-IB′ according to some example embodiments. FIG. 2A is a perspective view of the tray included in the packaging system of FIG. 1A according to some example embodiments. FIG. 2B, FIG. 2C, FIG. 2D, and FIG. 2E are orthogonal views of the tray of FIG. 2A according to some example embodiments.

Referring to FIG. 1A-1B, in some example embodiments, a packaging system 200 configured to hold one or more objects in place, via coupling the one or more objects with a tray 100, includes a flexible object 212. The tray 100 holds the flexible object 212, in a bent configuration, at least partially within a first cavity 110 of the tray 100, such that the bent flexible object 212 holds another object (first object 210) within the same first cavity 110.

The bent flexible object 212, engaged against one or more lugs of the tray such that the bent flexible objection 212 is held in place by the one or more lugs of the tray 100, holds the first object 210 within the first cavity 110 based on defining, in combination with one or more portions of the first cavity 110, a closed volume of space (referred to herein as “closed enclosure 250”) in which the first object 210 is enclosed within the first cavity 110. Thus, the first object 210 is precluded from exiting the first cavity 110, even though the first object 210 is not directly held (“fixed”) in place (e.g., fastened to the tray 100) by any portions (e.g., lugs) of the tray 100 itself.

Thus, the first object 210 is precluded from being removed from the first cavity 110, intentionally or unintentionally, while the bent flexible object 212 remains held in place by the tray 100. The bent flexible object 212 is held in place, in a bent configuration, by one or more lugs 112, 114 against which the bent flexible object 212 is engaged.

Referring to FIGS. 2A-2E, the packaging system 200 may include a tray 100 that includes one or more cavities 110, 120, 130 configured to hold one or more objects 210, 212, 220, 230 therein, such that the one or more objects are directly or indirectly held in place in relation to the tray 100. As referred to herein, each cavity of cavities 120 and 130 may be referred to as an “additional cavity” with regard to cavity 110, wherein an additional cavity is configured to hold an “additional object” (e.g., object 220, object 230, etc.) in relation to the one or more objects (e.g., objects 210, 212) held in cavity 110.

As shown in FIGS. 2A-2E, the tray 100 may include a planar tray portion 102 that extends along or substantially along a plane. In some example embodiments, the tray 100 includes one or more cavity portions (herein referred to as simply “cavities”) extending away from the plane along which the planar tray portion 102 extends, such that each cavity at least partially define one or more volume spaces (“at least partial enclosures,” “open enclosures,” or the like), respectively.

For example, as shown in FIGS. 2A-2E, the tray 100 may include one or more cavities 110, 120, 130, extending away from the plane along which the planar tray portion 102 extends. Each cavity may define a separate, respective open enclosure. As shown in FIGS. 2A-2E, for example, each cavity 110, 120, 130 defines a separate, respective open enclosure, such that each cavity includes an opening through which an object may be inserted into or removed from the open enclosure defined by the cavity, respectively.

Still referring to FIGS. 2A-2E, in some example embodiments, the tray 100 that includes a cavity may further include one or more lugs on one or more inner surfaces of the cavity. As referred to herein, an inner surface of a cavity of the tray may include a sidewall surface (e.g., sidewall surfaces 117) and/or a bottom surface (e.g., bottom surface 113) of the cavity. The one or more lugs may be configured to hold one or more objects in the cavity. As shown in FIGS. 2A-2E, for example, the tray 100 includes lugs 112, 114 extending along opposite (“opposing”) inner surfaces (e.g., at least two “opposing” sidewall surfaces 117) of first cavity 110, lugs 122 extending along opposite inner surfaces of cavity 120, and lugs 132 extending along opposite inner surfaces of cavity 130.

In some example embodiments, each lug included in the tray 100 may have one or more various cross-sectional shapes. A cross-sectional shape of a lug in the tray 100 may be a shape that is a protrusion from a surface of the tray. Such a protrusion may have a shape of a polygon, a curve, some combination thereof, or the like. In some example embodiments, a lug (e.g., one or more of lugs 112, 114) may have a parabolic cross-sectional shape, a trapezoidal cross-sectional shape, a triangular cross-sectional shape, or the like. Separate lugs in a set of lugs may have different, mirrored shapes. For example, in the example embodiments shown in FIG. 1B, lugs 112, 114 each have a separate, mirrored cross-sectional shape that corresponds to a curve that includes an indentation configured to accommodate a curvature of a surface of a bent flexible object 212, such that the surface of the bent flexible object 212 is held, by the lugs 112, 114, against at least a portion of the curvatures of the separate lugs 112, 114.

As shown in FIGS. 2A-2E, the lugs on one or more inner surfaces of a cavity may be symmetrical or asymmetrical in configuration. For example, cavities 120 and 130 include separate, respective sets of lugs 122, 132 that include symmetrically arranged (e.g., identically or substantially identically shaped and sized) lugs on opposite inner surfaces of the respective cavities. In another example, first cavity 110 includes an asymmetric configuration of dissimilar lugs 112, 114 extending along opposite inner surfaces of the first cavity 110.

Referring back to FIGS. 1A-1B, in some example embodiments, a set of lugs on an inner surface of a cavity are configured to hold a bent flexible object in place at least partially within the cavity, such that the bent flexible object and cavity collectively establish a closed space (“enclosure”) in which another, separate object that is isolated from direct contact with the set of lugs may be held.

As shown in FIGS. 1A-1B, for example, the lugs 112, 114 on the sidewall surfaces 117 of first cavity 110 are configured to hold a bent flexible object 212 in place, such that one or more surfaces (e.g., bottom surface 113) of the first cavity 110 and the bent flexible object 212 collectively define and establish a closed enclosure 250.

The flexible object 212 may be a planar object (e.g., a card, coupon, etc.) that is made of (“at least partially comprises”) a flexible material (e.g., paper, cardstock, plastic, etc.), such that the flexible object 212 may be bent, reversibly or irreversibly, into various shapes. In the example embodiments shown in FIGS. 1A-1B, for example, the flexible object 212 may be a paper coupon, initially in a planar configuration, that may be bent into a half-cylindrical and/or parabolic shape and engaged against and held in such a bent configuration by lugs 112, 114 and the bottom surface 113 and sidewall surfaces 117 of the first cavity 110. As shown, the lugs 112, 114 are configured to be in direct contact with (“engaged against”) the bent flexible object 212 such that the lugs 112, 114 at least partially hold the flexible object 212 in the bent configuration and in place with regard to the tray 100 to maintain the closed enclosure 250.

Still referring to FIGS. 1A-1B, at least one cavity of the tray 100 may be configured to hold multiple objects, where one of the objects is a bent flexible object that holds the other object in the tray 100 based on at least partially establishing a closed enclosure within which the first object is held.

As shown in FIGS. 1A-1B, a first object 210 may be placed within the first cavity 110 such that the first object 210 rests on the bottom surface 113 of the first cavity. As shown, the first object 210 is isolated from simultaneous direct contact with (e.g., is isolated from simultaneously engaging) each of the lugs 112, 114 on the sidewall surfaces 117 of the first cavity 110. As a result, the lugs 112, 114 do not directly hold the first object 210 in place within the first cavity 110.

As further shown in FIGS. 1A-1B, the flexible object 212 is held in place, in a bent configuration, by the lugs 112, 114 that the flexible object 212 is engaged against such that the flexible object 212 establishes a closed enclosure 250 that is bounded by the flexible object 212, the bottom surface 113 of the first cavity 110, and at least a portion of the sidewall surfaces 117 of the first cavity 110. As shown, the first object 210 is located within the closed enclosure 250. As a result, the first object 210 is held within the closed enclosure 250 by one or more surfaces of the first cavity 110 and by the flexible object 212 that is engaged against and held in place by the lugs 112, 114. While the first object 210 may be able to move within the closed enclosure 250, the first object 210 is precluded from exiting the closed enclosure 250. Thus, the first object 210 is held within the enclosure 250 by at least the bent flexible object. Thus, the first object 210 is held within the packaging system 200 and thus may be considered to be “held in place” within the packaging system 200.

Still referring to FIGS. 1A-1B, in some example embodiments, the packaging system 200 is configured to hold, in place within the packaging system 200, one or more various objects associated with an e-vaping device. Such objects may include a cartridge for an e-vaping device, including a pre-vapor formulation tank, pre-vapor formulation reservoir, vapor generator, flavor insert, some combination thereof, or the like. Such objects may include a power supply section for an e-vaping device, including a rechargeable battery. Such objects may include a charging device (“charger”) configured to recharge electrical power stored in the power supply section, including a universal serial bus (USB) charger, AC charger, DC charger, or the like, some combination thereof, or the like.

For example, in the example embodiments shown in FIGS. 1A-1B, the packaging system 200 may include a first object 210 that is a cartridge for an e-vaping device, a second object 220 that is a power supply section for an e-vaping device, and a third object 230 that is a charging device for an e-vaping device. The cartridge (first object 210) and the power supply section (second object 220) may be configured to be coupled together to form an e-vaping device. The charging device (third object 230) may be a rechargeable battery that is configured to be coupled with the power supply section (second object 220) to recharge a power supply included in the power supply section.

As described herein, an e-vaping device may include one or more of the features set forth in U.S. Patent Application Publication No. 2013/0192623 to Tucker et al. filed Jan. 31, 2013, the entire contents of which are incorporated herein by reference thereto. As used herein, the term “e-vaping device” is inclusive of all types of electronic vaping devices, regardless of form, size or shape.

Still referring to FIGS. 1A-1B, in some example embodiments, a packaging system 200 that includes, in tray 100, a first cavity 110 configured to hold a first object 210 therein, based on holding a flexible object 212 in place to establish a closed enclosure 250 in which the first object 210 is held, may enable improved efficiency of assembly of packaging configured to hold at least the first object 210.

For example, assembling a package that includes multiple objects 210, 220, 230, 212 held in place therein may require expenditures of assembler (e.g., human operator, machine, etc.) effort, time, and various resources. By enabling the first object 210 to be held in place in relation to the tray 100 by at least the bent flexible object 212, the packaging system 200 enables improved efficiency of assembly of a package in which at least the first object 210 is held in place therein.

For example, assembly of a package that includes the first object 210 and the flexible object 212 may include simply placing the first object 210 within the first cavity 110 and subsequently bending the flexible object 212 and placing the bent flexible object 212 in the first cavity 110 such that the lugs 112, 114 hold the bent flexible object 212 in place over the first object 210 to establish the closed enclosure 250.

Because the first cavity 110 is configured to hold the first object 210 without the first object 210 simultaneously engaging and/or directly contacting each of the lugs 112, 114, the first object 210 may be placed in the first cavity 110 without time and/or effort being expended to manipulate and/or bend the lugs 112, 114 to enable such placement.

In addition, because the flexible object 212 is flexible, the flexible object 212 may be bent to fit under the lugs 112, 114 as shown in FIGS. 1A-1B, reducing the expenditure of time and/or effort associated with holding the flexible object 212 in place, relative to the time and/or effort associated with manipulating and/or bending the lugs 112, 114 to accommodate an object held within the first cavity 110.

As a result, the time and/or effort expended to place the first object 210 and flexible object 212 into the tray 100, such that the flexible object 212 is bent and is engaged against and held in place by lugs 112, 114 to further hold the first object 210 within a closed enclosure 250, may be a reduced expenditure of time and/or effort relative to such expenditures associated with manipulating and/or bending lugs of the tray 100 to directly engage and hold the first object 210 in place in relation to the tray 100. Thus, the packaging system 200 is configured to be assembled, such that at least the first object 210 and flexible object 212 are held therein, with improved efficiency and reduced expenditures of costs, effort, and/or assembly time.

Furthermore, the packaging system 200 enables the flexible object 212 and the first object 210 to both be held in the same first cavity 110, where the flexible object 212 enables the first object 210 to be held in the first cavity 110 based on the lugs 112, 114 holding the flexible object 212 in place to establish the closed enclosure 250 in which the first object 210 is located. As a result, an amount of packaging material (e.g., tray 100 material) may be reduced, as excess material associated with directly engaging with, and holding in place, the first object 210 may be omitted. In addition, because both the first object 210 and the flexible object 212 may be held in a common first cavity 110, a size of the tray 100 configured to hold both the first object 210 and the flexible object 212 may be reduced, thereby improving packaging size efficiency and compactness. Such improved size efficiency and compactness may enable improved quantities of such packaging to be shipped, stored, and/or displayed.

In some example embodiments, the flexible object 212 may include information 211 on an upper surface thereof, as shown in FIG. 1B. As a result, in addition to holding the first object 210 in place in the first cavity 110, the flexible object 212 may further enable the observation and receipt of information that is included on the upper surface thereof.

The tray 100 may include various materials (e.g., plastic materials) and may be formed via various operations. For example, in FIGS. 1A-1B and 2A-2E, tray 100 may be a thermoformed tray that is formed via one or more thermoforming operations. Such one or more thermoforming operations may include heating an instance (e.g., sheet) of plastic, shaping the heated instance of plastic to a shape corresponding to the shape of the tray 100 in a mold, and trimming the shaped instance of plastic to establish the tray 100. In another example, tray 100 may be formed based on one or more vacuum forming operations being implemented with regard to an instance of plastic material.

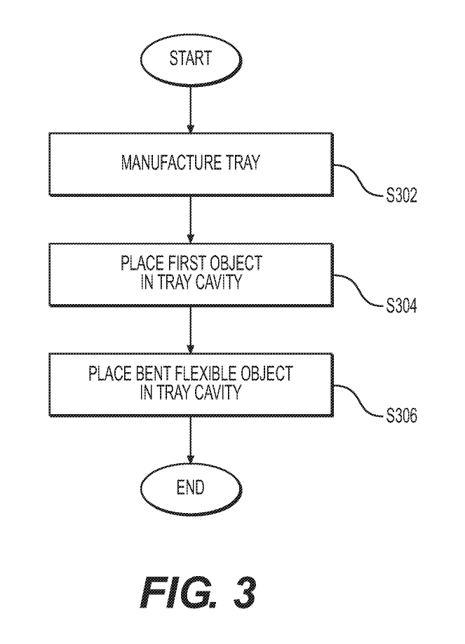

FIG. 3 is a flowchart illustrating a method for assembling a packaging system that includes a bent flexible object according to some example embodiments. The assembling may be implemented with regard to any embodiments of the packaging system included herein, including the packaging system 200 shown in FIG. 1A and FIG. 1B.

The assembling may, in some example embodiments, be implemented by an assembler that includes a human operator and/or a machine assembler. A machine assembler may be one or more devices that includes a manipulator device (e.g., a manipulator arm, a conveyer belt device, a thermoforming assembly (e.g., heater, mold, vacuum pump, and/or trimmer), some combination thereof, or the like), a memory (e.g., a non-transitory computer-readable storage medium) storing a program of instructions, and a processor (e.g., processing circuitry, including a CPU, ASIC, some combination thereof, or the like) configured to execute the stored program of instructions to control the manipulator device to perform the operations illustrated in FIG. 3.

At S302, a tray (e.g., tray 100) is manufactured. The tray 100 includes at least one cavity (e.g., first cavity 110) with at least one set of lugs (e.g., lugs 112, 114) on at least one inner surface (e.g., a sidewall surface 117) of the at least one cavity. The tray may be manufactured based on controlling one or more devices (e.g., a heater, mold, trimmer, etc.) to implement a thermoforming operation with regard to an instance of plastic (e.g., a sheet of plastic) to form the tray.

At S304, a first object (e.g., first object 210) is placed within the at least one cavity (e.g., first cavity 110) of the tray, such that the first object is isolated from directly contacting (“engaging”) each of the lugs of the cavity simultaneously. The first object may simply rest on a bottom surface (e.g., bottom surface 113) of the cavity and may be isolated from directly contacting any of the lugs of the cavity, as the first object may not be sufficiently large in size to simultaneously contact each of the lugs.

At S306, a flexible object is bent and placed at least partially into the cavity, such that the lugs of the cavity directly contact the bent flexible object and hold the flexible object in place, in the bent configuration, at least partially within the cavity. The bent flexible object thus, collectively with one or more surfaces of the cavity, establishes a closed space (“closed enclosure”) over the first object, such that the first object is precluded from exiting the cavity, by at least the bent flexible object directly and by the lugs of the cavity indirectly. Thus, the first object and the bent flexible object are both held in the packaging system.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

We claim:

1. A packaging system comprising:
a tray including a cavity and a set of lugs on an inner surface of the cavity;
a first object located within the cavity; and
a flexible object at least partially located within the cavity, the flexible object bent and engaged against the set of lugs such that
the flexible object is held in place at least partially within the cavity by the set of lugs, and
the first object is held within the cavity by the flexible object.

2. The packaging system of claim 1, the tray further including an additional cavity configured to hold an additional object within the additional cavity.

3. The packaging system of claim 2, wherein the additional object is a rechargeable battery.

4. The packaging system of claim 1, wherein,
the inner surface of the cavity includes two opposing sidewall surfaces, and
the set of lugs includes a separate lug on each wall of the two opposing sidewall surfaces.

5. The packaging system of claim 1, wherein the first object includes a cartridge for an e-vaping device.

6. A method comprising:
placing a first object within a cavity of a tray, the tray further including a set of lugs on an inner surface of the cavity, such that the first object is isolated from simultaneously engaging each lug of the set of lugs; and
placing a bent flexible object within the cavity, such that
the bent flexible object is held in place at least partially within the cavity by the set of lugs, and
the first object is held within the cavity by at least the bent flexible object.

7. The method of claim 6, wherein,
the tray further includes an additional cavity configured to hold an additional object within the additional cavity; and
the method further includes placing the additional object within the additional cavity, such that the additional object is held in place in the additional cavity.

8. The method of claim 7, wherein the additional object is a rechargeable battery.

9. The method of claim 6, wherein,
the inner surface of the cavity includes two opposing sidewall surfaces, and
the set of lugs includes a separate lug on each wall of the two opposing sidewall surfaces.

10. The method of claim 6, wherein the first object includes a cartridge for an e-vaping device.
